(19) United States
(12) Patent Application Publication
(10) Pub. No.: US 2015/0185790 A1
(43) Pub. Date: Jul. 2, 2015

(54) EXPANSION CARD CHASSIS ASSEMBLY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-CHANG FAN, Wuhan (CN)

(21) Appl. No.: 14/540,609

(22) Filed: Nov. 13, 2014

(30) Foreign Application Priority Data
Dec. 30, 2013 (CN) 201310741376.3

(51) Int. Cl. G06F 1/18

(52) U.S. Cl. CPC G06F 1/185; G06F 1/186

(57) ABSTRACT

A chassis assembly to hold multiple expansion cards includes a chassis and an expansion card combination. The chassis includes a back plate and a side plate. The back plate is perpendicular to the side plate. The expansion card combination includes a bracket. The bracket includes a holding plate and a fixing plate. The holding plate is perpendicular to the fixing plate. The fixing plate includes a fastening piece. The side plate includes an opening. The back plate includes a latching hole. The holding plate is held in the opening to prevent the expansion card combination from moving in the direction perpendicular to the back plate. The buckle and the latching hole are latched to prevent the expansion card combination from moving in the direction perpendicular to the side plate.

### CROSS-REFERENCE TO RELATED APPLICATIONS

This application claims priority to Chinese Patent Application No. 201310741376.3 filed on Dec. 30, 2013, the contents of which are incorporated by reference herein.

### FIELD

The subject matter herein generally relates to functionality of expansion card chassis assemblies.

### BACKGROUND

Electronic devices, such as microprocessor based computer systems, typically include expansion slots for connecting one or more expansion cards to the computer system. Expansion cards extend the capabilities of computer systems by providing dedicated hardware to achieve a variety of tasks.

### BRIEF DESCRIPTION OF THE DRAWINGS

Implementations of the present technology will now be described, by way of example only, with reference to the attached figures.

FIG. 1 is an exploded, isometric view of one embodiment of an expansion card chassis assembly.

FIG. 2 is an exploded, isometric view of an expansion card combination of the expansion card chassis assembly of FIG. 1.

FIG. 3 is a partially exploded, isometric view of the expansion card chassis assembly of FIG. 1.

FIG. 4 is an assembled view of the expansion card chassis assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to an expansion card chassis assembly.

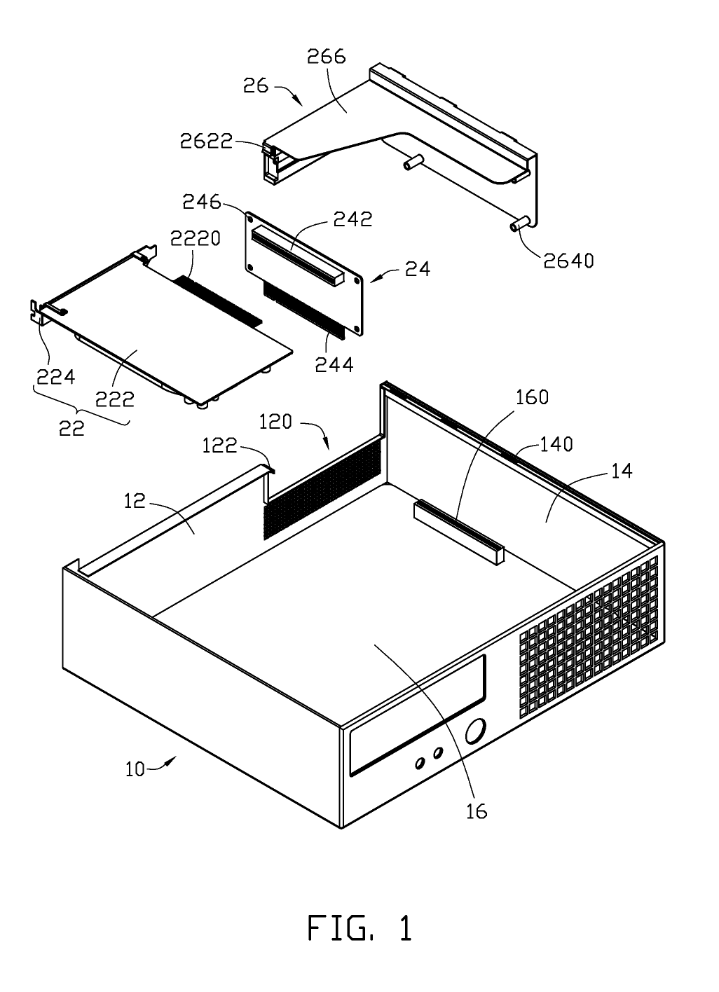

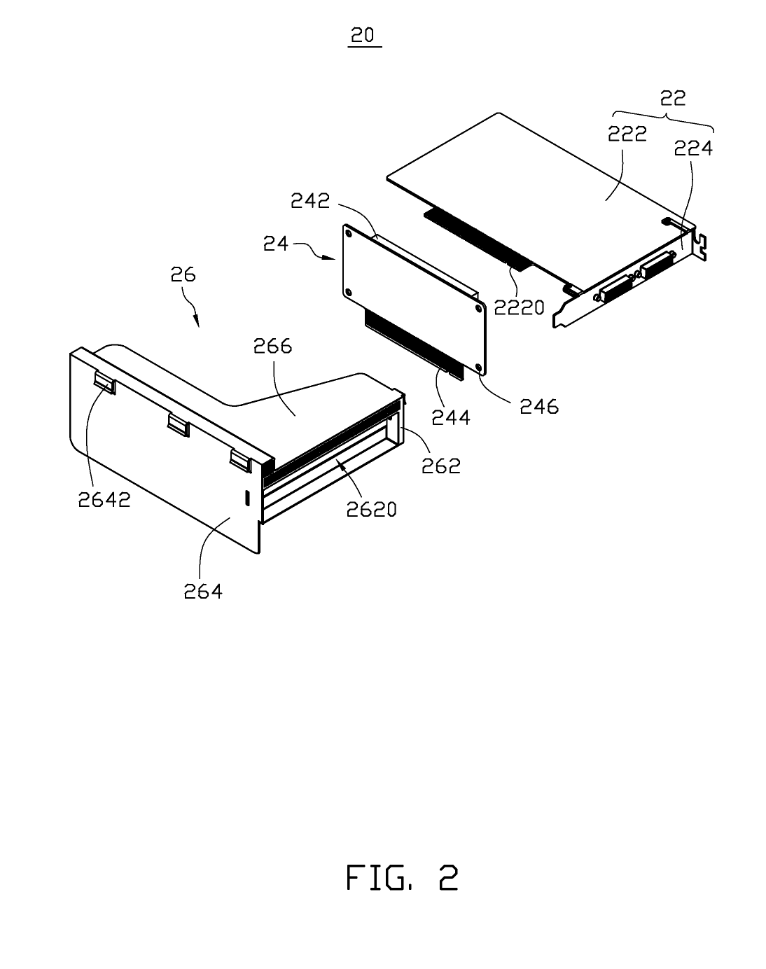

FIGS. 1 and 2 illustrate one embodiment of an expansion card chassis assembly for securing at least one expansion card 22 of large size. The expansion card chassis assembly includes a chassis 10 and an expansion card combination 20.

The chassis 10 includes a side plate 12, a back plate 14, and a bottom plate 16. The side plate 12 is perpendicular to the back plate 14. The bottom plate 16 is perpendicular to the side plate 12 and the back plate 14. The side plate 12 defines an opening 120 near the back plate 14. An edge of the side plate 12 defines a receiving hole 122 adjacent to the opening 120. The back plate 14 has a side edge and a top edge substantially perpendicular to the side edge. The side plate 12 has a back edge. The opening 120 is proximate to the back edge of the side plate 12. The back edge of the side plate 12 is coupled to the side edge of the back plate 14 with the side plate 12 positioned substantially perpendicular to the back plate 14. The top edge of the back plate 14 defines at least one latching hole 140 away from the bottom plate 16. An interface 160 is located on the bottom plate 16 near the back plate 14.

The expansion card combination 20 includes an expansion card 22, an adapter card 24, and a bracket 26. The expansion card 22 includes a main portion 222 and a locking tab 224. The locking tab 224 is located on an end of the main portion 222. The main portion 222 includes a first inserting part 2220. The adapter card 24 defines a slot 242, a second inserting part 244, and at least one fixing hole 246. An extension direction of the slot 242 is substantially perpendicular to an extension direction of the second inserting part 244.

The bracket 26 includes a holding plate 262, a fixing plate 264, and a supporting sheet 266. The holding plate 262 is perpendicularly connected to the fixing plate 264. One end of the supporting sheet 266 is connected to the holding plate 262. An opposite end of the supporting sheet 266 is connected to the fixing plate 264. The supporting sheet 266 is substantially perpendicular to the holding plate 262 and the fixing plate 264. The holding plate 262 is substantially perpendicular to the fixing plate 264. The holding plate 262 includes a receiving part 2620 and three spring clips 2622. Each spring clip 2622 extends from an edge of the receiving part 2620 away from the fixing plate 264. The fixing plate 264 includes at least one position post 2640 and at least one fastening plate 2642.

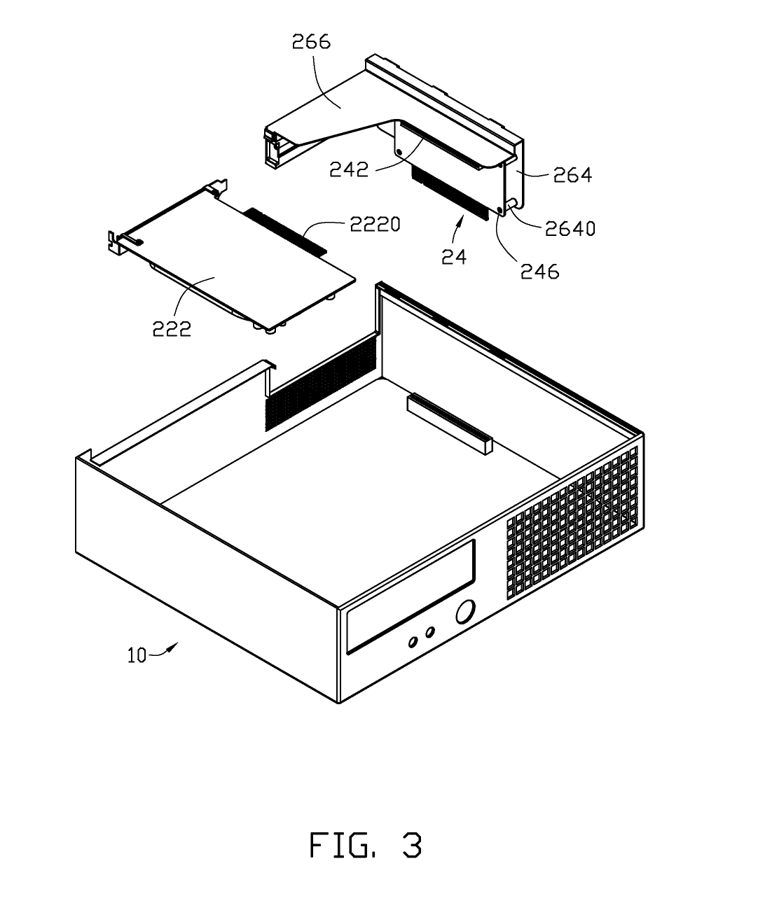

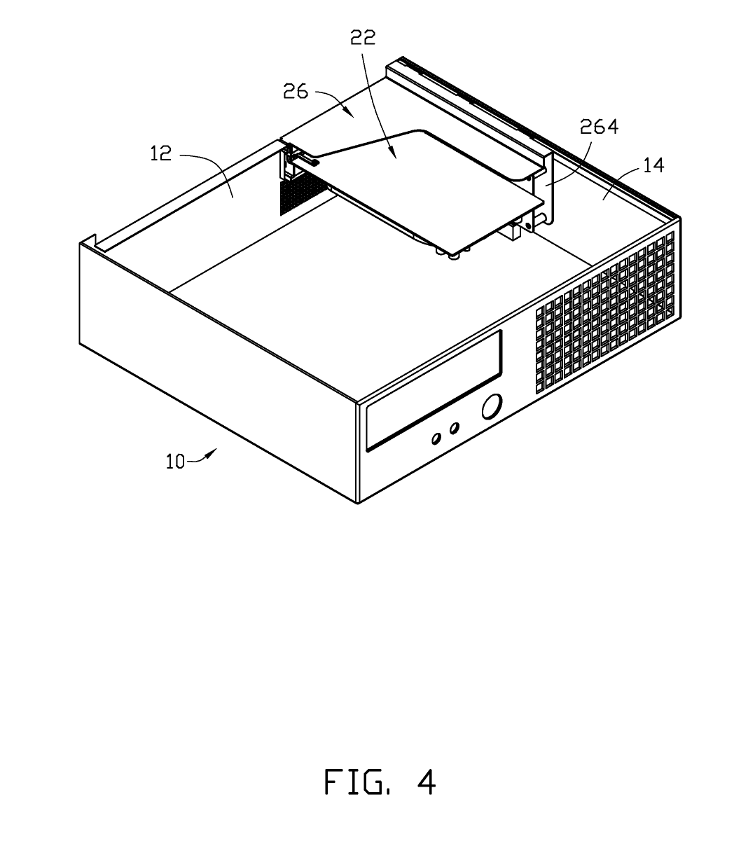

FIGS. 3 and 4 show two views of the assembled expansion card chassis assembly. In assembly, the adapter card 24 is closed to the fixing plate 264 of the bracket 26. The position post 2640 of the fixed plate 264 extends through the fixed hole 246 of the adapter card 24. The adapter card 24 is fixed with the fixing plate 264. The locking tab 224 of the expansion card 22 is inserted into the receiving part 2620 of the holding plate 262. The first inserting part 2220 of the main portion 222 is inserted in the slot 242 of the adapter card 24. The expansion card 22 is fixed with the holding plate 262 to prevent the adapter card 24 from disengaging from the fixing plate 264. The expansion card 22 is perpendicular to the adapter card 24. When the bracket 26 is moved down to the chassis 10, the spring clip 2622 of the holding plate 262 engages with the receiving hole 122. The fastening plate 2642 of fixing plate 264 is engaged with the latching hole 140 of the back plate 14. The second inserting part 244 of the adapter card 24 is inserted into the interface 160, to secure the bracket 26 to the chassis 10. The interface 160 is perpendicular to the slot 242. The bracket 26, the side plate 12, and the back plate 14 form a corner to enhance strength of the chassis 10.

In the above embodiment, the adapter card 24 and the expansion card 22 are fixed with the bracket 26, and the expansion card combination 20 is fixed with the chassis 10.

The embodiments shown and described above are only examples. Many details are often found in the art such as the other features of an expansion card chassis assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including, the full extent established by the broad general meaning of the terms used in the claims. It will therefore be appreciated that the embodiments described above may be modified within the scope of the claims.

What is claimed is:

1. An expansion card chassis assembly comprising;
a chassis having:
a back plate having a side edge and a top edge substantially perpendicular to the side edge; and
a side plate with a back edge, the back edge of the side plate coupled to the side edge of the back plate with the side plate positioned substantially perpendicular to the back plate;
wherein, there is an opening defined in the side plate proximate to the side plate back edge and a latching hole defined in the top edge of the back plate; and
an expansion card combination having a bracket with:
a holding plate; and
a fixing plate substantially perpendicular to the holding plate, the fixing plate having a fastening plate;
wherein, an adapter card is receivable by the expansion card combination;
wherein, an expansion card is receivable by the expansion card combination;
wherein, the holding plate is configured to be received in the side plate opening to inhibit movement of the expansion card combination in a first direction;
wherein, the fastening plate is configured to be received by the latching hole to inhibit movement of the expansion card combination in a second direction; and
wherein, the first direction is substantially perpendicular to the back plate and the second direction is substantially perpendicular to the side plate.

2. The expansion card chassis assembly of claim 1, wherein the expansion card combination comprises an adapter card, and the adapter card is mounted on the fixing plate.

3. The expansion card chassis assembly of claim 2, wherein the adapter card defines a slot, the expansion card comprises a first inserting part, and the first inserting part is inserted in the slot.

4. The expansion card chassis assembly of claim 1, wherein the expansion card combination comprises an expansion card, the holding plate defines a receiving part, the expansion card comprises a locking tab, and the locking tab is housed in the receiving part to prevent the expansion card from moving relative to the bracket.

5. The expansion card chassis assembly of claim 4, wherein the expansion card comprises a main portion, and the locking tab is perpendicular to the main portion.

6. The expansion card chassis assembly of claim 4, wherein the expansion card comprises a first inserting part, and the first inserting part is perpendicular to the locking tab.

7. The expansion card chassis assembly of claim 1, wherein the chassis comprises a bottom plate, the bottom plate defines an interface parallel to the back plate, the adapter card comprises a second inserting part, and the second inserting part inserted in the interface.

8. The expansion card chassis assembly of claim 7, wherein the second inserting part is perpendicular to the bottom plate.

9. The expansion card chassis assembly of claim 1, wherein the holding plate comprises a spring clip, the side plate defines a receiving hole, and the spring clip is engaged with the receiving hole to prevent the expansion card combination from disengaging from the chassis.

10. A chassis assembly comprising:
a chassis comprising a back plate and a side plate, the side plate defining an opening, and the back plate defining a latching hole; and
an expansion card combination comprising a bracket, an expansion card and an adapter card, the adapter card fixing with the bracket, the expansion card inserting in the adapter card, the bracket comprising a holding plate and a fixing plate, and the fixing plate comprising a fastening plate;
wherein the holding plate is configured to be received in the opening and the fastening plate is configured to engage with the latching hole.

11. The chassis assembly of claim 10, wherein the adapter card is substantially parallel to the fixing plate.

12. The chassis assembly of claim 10, wherein the adapter card defines a slot, the expansion card comprises a first inserting part, and the first inserting part is inserted into the slot.

13. The chassis assembly of claim 10, wherein the holding plate defines a receiving part, the expansion card comprises a locking tab, and the locking tab is housed in the receiving part to prevent the expansion card from moving relative to the bracket.

14. The chassis assembly of claim 13, wherein the expansion card comprises a main portion, and the locking tab is perpendicular to the main portion.

15. The chassis assembly of claim 13, wherein the expansion card comprises a first inserting part, and the first inserting part is perpendicular to the locking tab.

16. The chassis assembly of claim 10, wherein the chassis comprises a bottom plate, the bottom plate defines an interface parallel with the back plate, the adapter card comprises a second inserting part, and the second inserting part is inserted in the interface.

17. The chassis assembly of claim 16, wherein the second inserting part is perpendicular to the bottom plate.

18. The chassis assembly of claim 10, wherein the holding plate comprises a spring clip, the side plate defines a receiving hole, and the spring clip is engaged with the receiving hole to prevent the expansion card combination from disengaging from the chassis.
